(19) United States
(12) Patent Application Publication
(10) Pub. No.: US 2026/0084495 A1
(43) Pub. Date: Mar. 26, 2026

(54) Method for controlling at least one actuator unit of a motor vehicle, control device, and motor vehicle

(71) Applicant: AUDI AG, Ingolstadt (DE)

(72) Inventor: Karsten Belz, Ingolstadt (DE)

(73) Assignee: AUDI AG, Ingolstadt (DE)

(21) Appl. No.: 19/335,090

(22) Filed: Sep. 22, 2025

(30) Foreign Application Priority Data
Sep. 20, 2024 (DE) 10 2024 127 181.7

(51) Int. Cl. B60H 3/00; A63F 13/50; B60N 2/02; B60N 2/90; B60R 16/037

(52) U.S. Cl. CPC B60H 3/0007; A63F 13/50; B60N 2/0239; B60N 2/0273; B60N 2/976; B60R 16/037

(57) ABSTRACT

A method, a control device and/or a motor vehicle causing at least one actuator unit of the motor vehicle to be controlled by a control device configured to establish a user of the motor vehicle, establish at least one behavior and/or body language parameter of the user, and assign the at least one established user on basis of the behavior and/or body language parameter to a user-specific player category among multiple player categories. On basis of the user-specific player category of the at least one established user, the control device determines a set of actuator parameters assigned to the user-specific player category for the at least one actuator unit of the motor vehicle, and upon establishing starting of a computer game in the motor vehicle, generates an actuator signal that describes the set of actuator parameters, and transmits the generated actuator signal to the at least one actuator unit.

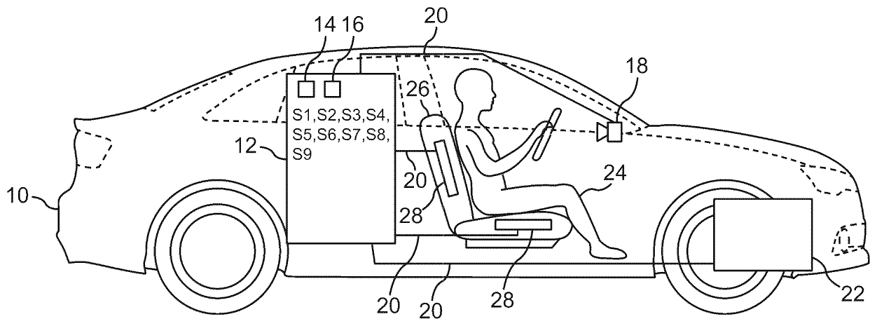

### CROSS-REFERENCE TO RELATED APPLICATIONS:

This application claims the priority benefit of German Patent Application No. 10 2024 127 181.7 filed on Sep. 20, 2024, which is incorporated by reference herein in its entirety.

### BACKGROUND

### 1. Field

An invention relates to a method for controlling at least one actuator unit of a motor vehicle, according to described examples. The invention also relates to the control device and the motor vehicle, according to described examples.

### 2. Description of the Related Art

Current motor vehicles will be able to drive more and more autonomously in future. For this reason, the passenger can also turn to other things in the vehicle. Among other things, “gaming”, i.e. playing computer games, is also finding its way into the vehicle interior in this context.

WO 2020/163801 A1 describes an intelligent media player, which configures interactive media using programmed methods, which are especially tailored to the passengers who temporarily use a common transport means (for example, an automobile or another vehicle).

Methods and devices for personalizing a vehicle using a sensor output device are known from US 2022/0224963 A1, which include: receiving a signal by way of one or more processors that indicates the identity or the passenger profile of a known passenger who is located in the vehicle or is entering the vehicle, accessing preference data and geographic location data of the passenger and selecting sensory content to be provided for the passenger in the vehicle based on the preference data and geographic location data. Also included are methods and devices for producing videos which are tailored to a preference profile of a person or cohort comprising linking each of the stored video clips with a set of characteristic parameters which relate to properties perceptible by the user, receiving user profile data which relate to the person or cohort, selecting video clips from the data structure at least partially based on the user profile data, and automatically producing a video which contains the preferred video clips.

US 2017/0136842 A1 describes that one or more suspension systems of a vehicle are used to alleviate travel sickness in that the movement is limited in one or more frequency ranges. An active suspension can be integrated in the architecture of an autonomous vehicle or the active suspension system of a vehicle can be used to induce movement in a vehicle.

### SUMMARY

One example object underlying the invention according to described examples may be to improve improving an immersive experience when playing computer games in the motor vehicle.

The stated example object may be achieved in each case by the method according to the examples of the invention and the devices according to the examples of the invention, according to the respective independent claims. Advantageous refinements may be provided by the dependent claims.

The invention according to the examples is based on the concept of initially characterizing the user of the computer game via the control of actuators during a use of computer games in the motor vehicle and controlling one or more actuator units of the motor vehicle in a character-specific manner on the basis of a player category in which a character of the user can be classified. Different users of computer games in the motor vehicle thus do not all experience the same immersive experience, but rather due to the individual control of one or more actuator units, each user of computer games experiences an actuator control tailored to the user personality. Thus, in other words, a player type—thus a “gamer type”—is taken into consideration in the control of actuators for an immersive experience in the motor vehicle when playing computer games.

An actuator unit is understood as a device or a device group having at least one actuator, thus having at least one drive element which converts an electrical signal or electrical signals into mechanical movement or another physical variable. An actuator unit can be configured as an infotainment system, climate control system, lighting system, fragrance system or fragrance device, seat mechanism or seat massage mechanism, or chassis.

With a configuration of the actuator unit as an infotainment system, for example, music can be selected and/or played in a controlled manner depending on the player type; with the configuration as a climate control system, for example, an airflow can be set to be weaker or stronger, for example, depending on whether the player is a calm or very agile player type; a light ambience can be set specifically for the player, as well as, for example, a seat massage, and in an example such a seat massage can be controlled in sync with the music being played during the computer game. If one of the controlled actuator units comprises an active chassis, this can give stronger or weaker haptic feedback depending on the player type, i.e. the intensity of haptic feedback can be adapted to the player type.

The method according to the examples of the invention for controlling at least one actuator unit of a motor vehicle can also be referred to as a method for player-specific setting of actuators of the motor vehicle or as a method for configuring actuators. The method is carried out by a control device.

A control device is understood as a device, a device group, or device component, which is configured to receive signals, analyze the signals received, and generate control signals and to transmit these control signals to other devices or device components. For this purpose, the control device can be configured, for example, as a controller or control chip and can comprise a receiver module, at least one microprocessor, and a transmitter module.

The control device establishes at least one user located in the motor vehicle, thus at least one user of the motor vehicle. The user can also be referred to here as the user of the motor vehicle, and/or as a user of computer games, or as a “player”.

The control device establishes at least one behavior and/or body language parameter of the at least one established user. The behavior and/or body language parameter can be, for example, the facial expression or the posture of the user. For this purpose, the control device can observe the user, for example, via a camera system of the motor vehicle, and analyze the behavior and/or the body language on the basis of image analysis. Alternatively or additionally, the control device, if the user has logged in with a user profile in the onboard system of the motor vehicle, for example, can retrieve properties of the user stored therein on the basis of the profile, for example, the property of the user “introverted”, “extroverted”, or “professional player”.

On the basis of the at least one established behavior and/or body language parameter, the control device assigns the established user to one of multiple predetermined player categories.

Thus, for example, a “professional player” can be recognized in that the user has a very professional facial expression when starting a computer game, information is provided to the control device that the user regularly plays computer games, or the control device can query, for example, via a display screen of the motor vehicle before starting the computer game whether the user refers to himself, for example, as a beginner or professional. The exemplary player category “communicative player” can be assigned to the established user if the control device establishes, for example, via a microphone pickup of a microphone of the motor vehicle that the user talks a lot during a journey, or that the user is registered on at least two social media platforms. An “extroverted player” can be recognized, for example, via gesture recognition on the basis of his expansive gestures, a player of the category “pay to win player”, for example, on the basis of information provided to the control device regarding subscriptions to in app purchases of computer games, and a player of the exemplary player category “isolated player” can be recognized, for example, in that this user often retreats into the parked motor vehicle in order to play a computer game. Further player categories may be the categories “aggressive player”, “gaming enthusiast”, “beginner”, and “casual gamer”.

On the basis of the player category to which the at least one established user is assigned, the control device determines a set of actuator parameters, assigned to the user-specific player category, for at least one actuator unit of the motor vehicle. The set can comprise, for example, a parameter for setting the temperature by way of the climate control system; a parameter which establishes a strength and a frequency of a seat massage and is directed to a motor vehicle seat mechanism; and/or a lighting parameter, which specifies to a lighting system of the motor vehicle, for example, lighting color and/or lighting strength for a user-specific ambient light during the computer game.

In an example, the set of actuator parameters can describe only one actuator parameter and only one actuator unit of the motor vehicle to be controlled.

Upon establishing starting of a computer game, thus upon establishing activation of the computer game in the motor vehicle, the control device generates an actuator signal which describes the determined set of actuator parameters and transmits this signal to the at least one actuator unit.

The abovementioned examples may result in advantages. For example, more realistic environment is provided in the motor vehicle by the method according to the examples of the invention, due to which the user experience when playing computer games becomes much better.

Establishing the user can comprise recognizing the user, wherein the control of the actuator unit or the actuator units is matched specifically to the person and thus more precisely.

In one refinement, it is provided that the control device establishes a user-specific mobile terminal in or at the motor vehicle to recognize the user and receives user-specific data on the mobile terminal, which identify the user, via a data communication connection to the mobile terminal. The mobile terminal can be configured, for example, as a smart phone, laptop, or tablet PC. The data communication connection can be a wireless data communication connection, thus, for example, a WLAN connection or a Bluetooth connection. The user-specific data which are stored on the mobile terminal can comprise, for example, the name of the user, characteristics of the user, and/or other suitable information for assigning and identifying the user.

Additionally or alternatively, to recognize the user, the control device can recognize the user on the basis of a provided user profile, for example, a user profile of the motor vehicle or the mobile terminal which the user has logged into.

Additionally or alternatively, to recognize the user, the control device can receive a user identification signal from a sensor unit, for example a sensor unit of the motor vehicle, and recognize the user on the basis of the received user identification signal. For this purpose, the control device can receive from the sensor unit, for example, a photograph of the face of the user and recognize the user by way of facial recognition software.

A sensor unit is understood as a device, a device group, or a device component which has at least one sensor for detecting a property, an object, and/or a person. The sensor unit can comprise at least one camera of the motor vehicle, a fingerprint sensor, and/or at least one microphone and speech analysis software.

The assignment into player categories can take place much more precisely due to the recognition of the user by one of the described measures. The immersive experience thus also becomes significantly better.

Alternatively to the mentioned user recognition, the control device can carry out a query before or during the playback of a computer game in which the user, for example, can input the user name and/or can press a button.

The control device can optionally establish, via a data communication connection with the mobile terminal of the user, at least one computer game that is stored on the mobile terminal and can assign the established user to a player category on the basis of the stored computer game. If the user has many sandbox games on the mobile terminal of the user, for example, thus many computer games with a high level of player freedom and significant creative space, the control device can establish, for example, the player category “casual gamer”. If the user has many so-called “first-person shooter” games stored on his mobile terminal, the control device can assign the player category “aggressive player” for this established user, for example. The assignment also becomes much more precise in this way, and the immersive experience thus becomes much better.

In a further method according to an example of the invention, the control device can establish the user specifically by seat. For this purpose, the control device can establish, for example, on the basis of camera recordings and/or pressure sensors in the motor vehicle seats where the established user is seated. Accordingly, the set of actuator parameters can only be provided specifically for this seat. This is very advantageous in particular if other occupants do not wish to participate in the immersive experience of the occupants playing the computer game, or if multiple different player types play in the motor vehicle.

In one refinement, with a plurality of users in the motor vehicle, one or more actuator units can then accordingly be controlled specifically by seat, so that different player types can play simultaneously and each user has a particularly personal immersive experience. In this refinement, the control device can establish at least two users in the motor vehicle specifically by seat, assign a player category to each of the established users, and generate an actuator signal for control specifically by seat of at least one actuator unit in each case for each of the established users. The actuator signals can thus differ, for example, so that for each of the users, different actuators and different actuator parameters can be set.

In a further method according to an example of the invention, the games can be pre-filtered, so that the user can only select a game from a selection compiled specifically for him to play. For this purpose, the control device can provide at least one computer game suitable for the established user for selection from a plurality of provided computer games on the basis of the player category to which the established user is assigned. In the case of pre-filtering of the games, the selected games can optionally each be represented by a colored icon on a display screen of the motor vehicle and the icons for other games which have been rejected can optionally be shown grayed out.

As an alternative to the preceding method according to an example of the invention, it can be provided that the control device provides at least one computer game of a player category other than the one assigned to the established user to the established user for selection. In this way, the user can try out something new and the player can try out and experience new things through the correspondingly different control of actuator units. If the established user belongs, for example, to the player category “aggressive player” and essentially only plays “first-person shooters”, the inducement to play a strategy game instead may allow the user to change to a more relaxing game genre.

For applications or application situations which can result in the method and are not explicitly described here, it can be provided that according to the method an error message and/or a request to input user feedback is output and/or a standard setting and/or a predetermined initial state is set.

The invention according to the example also includes the control device for the motor vehicle. The control device can have a data processing device or a processor unit (processor circuit), which is configured to carry out the method according to the examples of the invention. The processor unit can have for this purpose at least one microprocessor and/or at least one microcontroller and/or at least one FPGA (Field Programmable Gate Array) and/or at least one DSP (Digital Signal Processor). In particular, a CPU (Central Processing Unit), a GPU (Graphical Processing Unit), or an NPU (Neural Processing Unit) can each be used as the microprocessor. Furthermore, the processor unit can have program code which is configured, when it is executed by the processor unit, to carry out the method according to the examples of the invention. The program code can be stored in a data memory of the processor unit. The processor unit can be based, for example, on at least one circuit board and/or on at least one SoC (System on Chip).

The motor vehicle according to the examples of the invention may be configured as an automobile, in particular as a passenger vehicle or truck, or as a bus or motorcycle, and has a control device according to the examples of the invention.

As a further solution, the invention according to the examples also comprises a computer-readable storage medium, comprising program code, which, when it is executed by a computer or a computer network, causes it to carry out the method according to the examples of the invention. The storage medium can be at least partially provided as a nonvolatile data memory (for example, as a flash memory and/or as an SSD (solid-state drive)) and/or at least partially as a volatile data memory (for example, as a RAM (random access memory)). The storage medium can be arranged in the computer or computer network. The storage medium can also be operated, for example, as a so-called app store server and/or cloud server in the Internet, however. A processor circuit having, for example, at least one microprocessor can be provided by the computer or computer network. The program code can be provided as binary code and/or as assembler code and/or as a source code of a programming language (for example, C) and/or as a program script (for example, Python). The computer-readable storage medium can alternatively be implemented by a signal having computer-readable data, for example, a time-variant voltage signal and/or a radio signal.

The invention according to the examples also includes refinements of the control device according to the examples of the invention and the motor vehicle according to the examples of the invention, which have features as have already been described in conjunction with the refinements of the method according to the examples of the invention. For this reason, the corresponding refinements of the control device according to the examples of the invention and the motor vehicle according to the examples of the invention are not described again here.

The invention also comprises the combinations of the features of the described examples. The invention thus also comprises implementations which each have a combination of the features of several of the described examples, if the examples have not been described as mutually exclusive.

### BRIEF DESCRIPTION OF DRAWINGS

Examples of the invention are described hereinafter.

For this purpose, the single FIGURE (“Figure”) shows a schematic representation of a method according to an example the invention and devices according to an example of the invention.

### DESCRIPTION

The examples explained hereinafter are examples of the invention. In the examples, the described components of the examples each represent individual features of the examples of the invention to be considered independently of one another, which each also refine the examples of the invention independently of one another. The disclosure is therefore also intended to comprise combinations of the features of the examples other than those shown.

Furthermore, the described examples can also be supplemented by further features of the examples of the invention which have already been described.

In the FIGURE, identical reference signs each identify functionally-identical elements.

The FIGURE schematically shows a method according to examples of an invention and devices according to examples of an invention. For this purpose, the FIGURE shows a motor vehicle 10, for example, a passenger vehicle, having a control device 12, which can be configured, for example, as a control chip or controller. The control device 12 can have at least one processor unit 14 and/or at least one data memory 16.

The control device 12 communicates with a camera 18, shown as an exemplary sensor, via a data communication connection 20, which can be configured, for example, as a data BUS of the motor vehicle 10, or which can be a wireless data communication connection, for example. The control device 12 can likewise communicate via a data communication connection 20, for example, with an infotainment system 22 of the motor vehicle, which can optionally have a display screen to output user queries and/or computer games. Alternatively, for example, smart glasses can be used to output the computer game.

In the example of the FIGURE, a user 24 is located in the motor vehicle on a motor vehicle seat 26, for example, on the front passenger seat. As an exemplary actuator unit 28, the motor vehicle seat can have a mechanism and electronics for carrying out a seat massage in the backrest and/or in the seat cushion. The motor vehicle 10 can have still further actuator units 28, which can be controlled specifically for the player. Examples of this were already mentioned above.

In the case of an optional communication with a mobile terminal (not shown in the FIGURE) of the user 24, the data communication connection 20 can be wireless, for example, a Bluetooth or WLAN connection.

In the example of the FIGURE, the control device 12 can establish in S1, for example, via a camera image of the user 24 and a facial recognition analysis, the user as the owner of the motor vehicle 10. The control device 12 can establish here, for example, that the corresponding signal comes from a camera 18 which only films the front passenger seat, and accordingly the user 24 can be established (S1) specifically by seat for the front passenger seat. If a further user (not shown in the FIGURE) is located on another seat, this can also be established specifically by seat (S1).

The camera 18 can record, for example, a video of the established user 24 and transmit a corresponding signal to the control device 12. On the basis of an analysis of posture and/or physical movements, and of facial expression, the control device 12 can establish (S2), with the aid of an artificial intelligence, thus a neural network, at least one behavior and/or body language parameter and establish, for example, by analysis, a tense facial expression as a facial expression and expansive extroverted movements as body language or physical movement.

Alternatively or additionally, to recognize the user 24, the control device 12 can establish, for example, from a mobile terminal, a serial number of the mobile terminal or personal information of the user 24. For this purpose, the control device 12 can establish a data communication connection to the mobile terminal, for example, a WLAN connection, establish the mobile terminal as such (S3) or establish it as the mobile terminal of the user 24 (S3), and receive the corresponding data on the user 24 (S4). These data can describe, for example, the name of the user 24. Alternatively, the control device 12 can read, for example, a user profile in an onboard system of the motor vehicle 10 if the user has logged in.

The user 24 of the example of the FIGURE can be classified, for example, on the basis of expansive physical movements of the user and the tense facial expression in the player category “aggressive player” or “extroverted player”, i.e. can be assigned to this player category (S5).

Alternatively or additionally, the assignment S5 can take place via a computer game collection in the onboard system of the motor vehicle 10 or on the mobile terminal of the user 24. In the example of the FIGURE, for example, a game collection having many so-called “first-person shooters” can produce the assignment S5 to the player category “extroverted player”.

In the example, it can be provided for the player category “extroverted player”, for example, that a light system of the motor vehicle 10 is controlled, for example, such that the light is very bright and flickers at a high frequency. The motors of the seat massage function of the actuator unit 28 shown as an example in the FIGURE can be actuated for this player category, for example, such that strong, rapidly changing exertions of pressure of the backrest and the seat surface are exerted on the user 24 in rapid cycles. If it is also provided for the player category of the example that the infotainment system 22 plays back predetermined music or information is stored on which music is played for a computer game, this massage function can be controlled such that the seat massage is carried out in sync with the music being played. The corresponding category-specific set of actuator parameters is determined by the control device in S6.

To establish starting or activating of a computer game, the control device 12 can either initiate the starting of the computer game itself, or receive corresponding information from the onboard system of the motor vehicle 10. The control device 12 generates in S7 an actuator signal which describes for the actuator unit 28 shown in the FIGURE and, for example, also for a lighting system having the corresponding actuator parameters, and the control device transmits this in S8 to the respective actuator unit 28.

If there are multiple users 24, a user-specific actuator signal can be generated specifically by seat (S7).

Optionally, only a portion of computer games or only one computer game from a computer game collection can be provided to the established user for selection (S9). The selection can take place on the basis of the player category of the established user 24, or one computer game or multiple computer games from a different player category are proposed to the established user 24 in order to try out a new computer game genre. The computer game collection can be one of the mobile terminal of the user 24, or a computer game collection which can be stored in the data memory 16 of the control device 12 or in another data memory of the motor vehicle 10.

Overall, the examples show how a method and a device for recognizing gamer types in the vehicle interior and corresponding adaptation of gaming can be provided.

The core of the concept may be that when the user 24 activates gaming (thus starts a game), the gamer type is ascertained, for example, via a manual or automatic query (S5), and the motor vehicle 10 adjusts itself thereto as a whole.

Which gamer type (thus which player type) is located in the motor vehicle 10 can be ascertained (S5) in a further example via one or more different paths, for example:
query of the personal device; and/or
manual query upon the first game; and/or
automatic recognition by a game observation by sensors in the interior.

The following settings can be carried out depending on the gamer type:
only offer games (integrated in the motor vehicle 10) which correspond to the gamer type (prefiltering), and/or
perform corresponding settings on the actuators in the interior; for example, in the case of a “hardcore” gamer, light can accordingly be featured in a brighter and more active manner and the music can be turned up.

Further differentiations of the settings are conceivable. This feature can be used for autonomous and/or non-autonomous motor vehicles 10. This can be used both for the front area and for the rear area. This function can optionally be selected adjustably by the user 24.

Advantageously, among other things, this device and/or this method give the user 24 an additional benefit when using gaming in motor vehicle 10 of the user 24.

In a further technical implementation, the motor vehicle 10 having a controller as the control device 12 can be equipped with corresponding software for gaming. An evaluation of the recognition and electronic display, processing of the data and a corresponding output and setting of gaming, and/or forwarding of information to the vehicle occupants can take place via, for example, speech and/or HMI, thus, for example, via speech and/or an operating device having a user interface.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d 1865 (Fed. Cir. 2004).

1. A method of controlling by a control device of a motor vehicle at least one actuator unit among actuator units of the motor vehicle, comprising:
by the control device configured to execute a process that
establishes a user located in the motor vehicle,
establishes at least one behavior and/or body language parameter of the user,
assigns the user on basis of the at least one behavior and/or body language parameter to a user-specific player category among multiple player categories for computer games,
on basis of the user-specific player category of the user, determines a set of actuator parameters assigned to the user-specific player category for at least one actuator unit,
upon establishing starting of a computer game in the motor vehicle, generates an actuator signal that describes the set of actuator parameters, and
transmits the actuator signal to the at least one actuator unit to control the at least one actuator unit.

2. The method according to claim 1, wherein establishing the user comprises recognizing the user and the control device to recognize the user executes at least one recognizing process among recognizing processes that:
establishes a user-specific mobile terminal in or on the motor vehicle and receives user-specific data, which identify the user, on the user-specific mobile terminal via a data communication connection to the user-specific mobile terminal;
recognizes the user on basis of a provided user profile; and/or
receives a user identification signal from a sensor unit and recognizes the user on basis of the user identification signal.

3. The method according to claim 1, wherein to assign the user-specific player category, the control device establishes, via a data communication connection to a mobile terminal of the user, at least one computer game that is stored on the mobile terminal, and assigns the user to the user-specific player category on basis of the at least one computer game.

4. The method according to claim 1, wherein to establish the user, the control device establishes the user by a seat among seats in the motor vehicle.

5. The method according to claim 4, wherein the user is at least two users and to establish the at least two users, the control device establishes the at least two users in the motor vehicle by the seats, respectively, assigns a user-specific player category to each user of the at least two users established, and for each user of the at least two users established, generates an actuator signal to control at least one actuator unit among the actuator units in the seats, respectively.

6. The method according to claim 1, wherein the control device provides, from a plurality of computer games, at least one computer game for selection as suitable for the user on basis of the user-specific player category to which the user is assigned.

7. The method according to claim 1, wherein the control device provides a selection to the user of at least one computer game of a different player category than the user-specific player category to which the user is assigned.

8. The method according to claim 1, wherein the actuator units are configured as system among systems including an infotainment system, a climate control system, a lighting system, a fragrance system, a seat or seat massage system, and/or as a chassis.

9. A control device for a motor vehicle, comprising:
at least one processor configured to execute a process that
establishes a user located in the motor vehicle,
establishes at least one behavior and/or body language parameter of the user,
assigns the user on basis of the at least one behavior and/or body language parameter to a user-specific player category among multiple player categories for computer games,
on basis of the user-specific player category of the user, determines a set of actuator parameters assigned to the user-specific player category for at least one actuator unit,
upon establishing starting of a computer game in the motor vehicle, generates an actuator signal that describes the set of actuator parameters, and
transmits the actuator signal to at least one actuator unit among actuator units to control the at least one actuator unit.

10. The control device according to claim 9, wherein establishing the user comprises recognizing the user and the control device to recognize the user executes at least one recognizing process among recognizing processes that:
establishes a user-specific mobile terminal in or on the motor vehicle and receives user-specific data, which identify the user, on the user-specific mobile terminal via a data communication connection to the user-specific mobile terminal;
recognizes the user on basis of a provided user profile; and/or
receives a user identification signal from a sensor unit and recognizes the user on basis of the user identification signal.

11. The control device according to claim 10, wherein to establish the user, the control device establishes the user by a seat among seats in the motor vehicle.

12. The control device according to claim 11, wherein the user is at least two users and to establish the at least two users, the control device establishes the at least two users in the motor vehicle by the seats, respectively, assigns a user-specific player category to each user of the at least two users established, and for each user of the at least two users established, generates an actuator signal to control at least one actuator unit among the actuator units in the seats, respectively.

13. A motor vehicle comprising:
a control device configured with at least one processor configured to execute a process that
establishes a user located in the motor vehicle,
establishes at least one behavior and/or body language parameter of the user,
assigns the user on basis of the at least one behavior and/or body language parameter to a user-specific player category among multiple player categories for computer games,
on basis of the user-specific player category of the user, determines a set of actuator parameters assigned to the user-specific player category for at least one actuator unit,
upon establishing starting of a computer game in the motor vehicle, generates an actuator signal that describes the set of actuator parameters, and
transmits the actuator signal to at least one actuator unit among actuator units to control the at least one actuator unit.

14. The motor vehicle according to claim 13, wherein establishing the user comprises recognizing the user and the control device to recognize the user executes at least one recognizing process among recognizing processes that:
establishes a user-specific mobile terminal in or on the motor vehicle and receives user-specific data, which identify the user, on the user-specific mobile terminal via a data communication connection to the user-specific mobile terminal;
recognizes the user on basis of a provided user profile; and/or
receives a user identification signal from a sensor unit and recognizes the user on basis of the user identification signal.

15. The motor vehicle according to claim 13, wherein to establish the user, the control device establishes the user by a seat among seats in the motor vehicle.

16. The motor vehicle according to claim 15, wherein the user is at least two users and to establish the at least two users, the control device establishes the at least two users in the motor vehicle by the seats, respectively, assigns a user-specific player category to each user of the at least two users established, and for each user of the at least two users established, generates an actuator signal to control at least one actuator unit among the actuator units in the seats, respectively.
